(19) United States
(12) Patent Application Publication
(10) Pub. No.: US 2025/0282658 A1
(43) Pub. Date: Sep. 11, 2025

(54) EMF Generator To Selectively Tune the Generated EMF to Specific Frequencies Using a Pulse-width Modulator and Methods Related Thereto

(71) Applicant: Cirrus Ecowater, LLC, Henderson, NV (US)

(72) Inventors: Stephen Clausi, Henderson, NV (US); Gary Wilson, Henderson, NV (US)

(21) Appl. No.: 19/074,423

(22) Filed: Mar. 9, 2025

Related U.S. Application Data
(60) Provisional application No. 63/563,029, filed on Mar. 8, 2024.

(51) Int. Cl. C02F 1/48; H01F 7/06

(52) U.S. Cl. CPC C02F 1/487; C02F 1/485; H01F 7/064

(57) ABSTRACT

An EMF-generating device with a pulse-width modulator and option switch and timer are used to selectively adjust the EMF (and existing static magnetic field) at specific frequencies target ions in suspension or dissolution such that, once the water is treated, the ions are able to remain in the water in a colloidal state longer and in a higher concentration and the water passing through the treatment device undergoes its own reorganization in terms of the density and strength of the hydrogen bonding.

### TECHNICAL FIELD

The present disclosure relates generally to systems and methods for disrupting and activating phases in aqueous suspension. More particularly, the disclosure relates to tuning one or more electromagnetic fields (EMFs) to selective frequencies which target specific native molecules in suspension.

### BACKGROUND

Water is involved in every aspect of society. It is integral to every economy and it is becoming increasingly scarce. Supply chains, businesses and communities are at risk from water scarcity. The U.N. estimates that the world will face a 40 percent freshwater deficit by 2030 if nothing is done to change the way we use and preserve water.

Despite its critical role in every life and economy, not all water is the same. Hard water is water that has high mineral content (in contrast with “soft water”). Hard water is formed when water percolates through deposits of limestone, chalk, gypsum, or other mineral deposits, which are largely made up of calcium and magnesium carbonates, bicarbonates and sulfates, but can include other mineral elements. As the water interacts with the mineral deposits, mineral ions (molecules of the mineral's native elements or compounds) are picked up and either suspended or dissolved in the water. Ions that are in solution in the water remain dissolved until the water becomes over saturated with the solutes either by evaporation or a change in temperature. The ions may then form larger particles and become nucleation sites for further growth and accumulation of ions. These newly formed precipitates can remain suspended in the water as sediment, or they can attach to a surface to form mineral deposits known as ‘scale.’

Hard water for human consumption may have moderate health benefits. However, it can pose critical problems for other applications in both industrial and domestic settings. For example, hard water is known to form surface deposits on plumbing, valves, cooling towers, pipes, and nearly any surface with which it comes into contact. When hard water causes scale on surfaces, it can impact the efficiency of equipment. For example, hard water is known to leave scale on plumbing equipment such as shower heads, which reduces water flow. Scale can also build up in pipes, reducing the effective diameter of the pipe, or plumbing valve function. Similarly, the use of hard water in cooling towers leads to scale buildup on a heat exchange, which reduces the efficiency of the heat exchange. Where possible in industrial applications water hardness is often monitored to avoid costly breakdowns in boilers, cooling towers, and other equipment that handles water. Many industrial applications currently utilize chemical techniques to remove or reduce scale.

In addition to scale build up, hard water also diminishes the effectiveness of surfactants. Surfactants such as soaps and detergents, used for cleaning surfaces and antimicrobials used for disinfecting surfaces will be devitalized when hard water is used as part of the application. End users will be required to employ greater amounts of the surfactant substance (e.g. detergent or disinfectant) in order to profit from the application. This will hold true of any substance that relies on surfactant ingredients for its effectiveness. To resolve this issue, water softening is commonly employed to reduce the adverse effects of hard water.

Currently there are two conventional ways to treat hard water. The most common treatment is to add corrosive chemicals to break down the scale. Treating water with harsh chemicals over time can damage equipment and the environment and leave the water unusable for subsequent applications. The second is by employing a water softener, which uses chemical catalysis to replace the ‘hard-water’ ions with other ions that do not contribute to the ‘hardness’ of the water, such as sodium. However, the corrosive chemicals are expensive, environmentally harmful and can damage equipment and there are many applications that cannot tolerate the addition of sodium to the water. Furthermore the rising sodium levels in the waste water from water softeners is becoming an environmental concern.

Another method to treat hard water is with a patented device previously disclosed in U.S. Patent Application No. 62/128,908 for Systems and Methods for Controlling Electric Fields in a Fluid, Gases and Bacteria and U.S. Pat. No. 11,261,110 for Systems and Methods for Controlling Evaporative Loss. The first discloses an electric and magnetic field inducing device with a notched malleable core and electrically conductive windings wrapped around the flexible core around the notches and an insulative coating isolates the windings from the core. The second reference discloses a system for reducing evaporative cooling water losses using an electric and magnetic field inducing device comprising a malleable core with notches, electrically conductive windings wrapped around the flexible core around the notches and an insulative coating isolates the windings from the core. Both U.S. Patent Application No. 62/128,908 and U.S. Pat. No. 11,261,110 are incorporated herein by reference. The patented device described in these references is used to reduce the need for chemical treatments to reduce scaling buildup, especially in regions with hard water.

The above advances, while effective, represent a ‘one-size-fits-all’ solution to the problems presented by hard water. Different regions contain different hard water chemical profiles. For example, the hard water in some regions may include a greater concentration of magnesium ions, while in other regions it may have more calcium ions and still others may include silicon or phosphorous ions. Moreover, no device or method exists that selective tunes the applied electromagnetic fields (EMFs) of a water treatment device to specific frequencies in order to target the elements, molecules, colloids or compounds that present in the water, as well as the water itself. Further, no device exists that is able to tune the applied electromagnetic fields (EMFs) of a water treatment device to specific frequencies in order to target the elements, molecules, colloids or compounds that present in the water, as well as the water itself. Further, no device or method exist that selectively tunes EMFs to specific frequencies for specific elements, molecules, compounds, liquids and sediments as well as the water itself. Therefore, there exists a need to have the ability to tune the EMFs being applied as well as change the direction of the EMF lines, to treat hard water based on the composition profile of the water.

### BRIEF SUMMARY

The general purpose of the systems and methods disclosed herein is to provide an improved EMF generator that includes the ability to tune the generated EMF to specific frequencies or frequency bands using a pulse-width modulator, or similar electronic device to add low levels of energy into the water to increase the water's stored evaporative energy; disrupt the process of limescale and other hard water formations; and inhibit the growth of bacteria. More specifically, the systems and methods disclosed herein tune specific frequencies of EMF, not merely radio waves, to specific elements, molecules, compounds, liquids and sediments as well as the water itself. Pulse-width modulation (“PWM”), or pulse-duration modulation (PDM), is a method of controlling the average power delivered by an electrical signal. The average value of voltage (and current) fed to the load is controlled by switching the supply between 0 and 100% at a rate faster than it takes the load to change significantly. The combination of a pulse-width modulator along with an EMF generating system generates a gradient electromagnetic field, with the pulse-width modulator tuned to generate the desired disruptive frequencies and strength of the electromagnetic field, to more effectively promote activation for specific mineral ions suspended in an aqueous solution. Furthermore, the circuit included in the design allows the current in the device to switch directions. The device is based on a direct current supply. Switching the direction of direct current allows for a more effective treatment of the water as it reverses the direction of the EMF gradient. The circuit that switches the current direction is on a timer that can be adjusted by the installer or end user.

The overall system contains an EMF generator able to generate specific frequencies, and thus be tuned or tunable to resonate with and/or excite the phases in suspension and disrupt the equilibrium of charged particles in the water. Moreover, the design allows for modulating the distance between the EMF-generating nodes or bundles, which modulates the dynamic energy field interactions with the particles in suspension. The design also allows for modulating the time ratio of the primary setting to the secondary setting (switching the current direction), which improves the effectiveness of the interference with the particles in suspension and prevents the water from returning to a state of charge equilibrium. The ratio in some instances is 2:1, but can be as low as 0.01:1 and as high as 10:1. This apparatus is designed to work in conjunction with any application where an aqueous fluid is in flow through a conduit of any size. Applications include but are not limited to irrigation, filtration, cooling and heating, medicine delivery, cleaning and disinfecting, as well as all potable water uses. It also is designed to work in conjunction with non-aqueous liquids and gases.

In some embodiments the three things that the device can “switch” or “modulate” are first, the direction of current (or “polarity”), second, is the tuned frequency, and third is the distance between the windings or the EMF-generating nodes. The device could be set to generate an electromagnetic field at a specific frequency for a set time interval, then switch to a second specific frequency for another time interval. In this way, the device can target more than one ion species in the fluid (water). Furthermore, there is nothing that limits this ability to two specific frequencies. The device can be engineered to generate any number of specific frequencies for a set (adjustable) duration. This is especially significant in an application where the fluid is recirculated and the device is placed on the recirculating conduit. An example of this would be a cooling tower's recirculating water system.

Pure double distilled water or DDH₂0 is a ‘net neutral’ fluid, meaning it maintains a neutral electronic charge. The addition of hard-water minerals and elements suspended and dissolved in the water consist of charged cations and anions which are positively or negatively charged. For this reason, the ions in the water can be impelled to move, dissociate or otherwise change their nearest-neighbor configurations when an electric current, such as in electrolysis, is applied. The application of an external EMF, as created by the EMF generator disclosed herein, initiates a change in the ions that are in solution, creating an environment where more of the mineral ions can be kept in solution. As disclosed herein, the effectiveness of the EMF to initiate this change is increased when the frequency is coordinated to a specific target ion, and the polarity of the EMF is alternated to effect a greater number of the target ions.

In one non-limiting embodiment, an EMF generator comprising a malleable core with bundling cites. In some embodiments bundling cites comprise notches with electrically conductive windings wrapped around the flexible core at the notches and an insulative coating isolating the windings from the core. Some embodiments further comprise a relay that reverses the polarity of the circuit. In some embodiments the relay is coupled to a timer to determine the time interval between reversing the polarity. Some embodiments switch the tuned EMF frequencies for a set time.

The EMF described herein affects water in multiple ways including but not limited to: the ions in suspension or dissolution are affected by the electromagnetic field (and existing static magnetic field) such that, once the water is treated, the ions are able to remain in the water in a colloidal state longer and in a higher concentration (this reduces or reverses scale buildup and may have other affects in other applications such as nutrient exchange in organisms). The second affect is that the water passing through the treatment device undergoes its own reorganization in terms of the density and strength of the hydrogen bonding (thereby changing the evaporation behavior and surface energy of the water and possibly changing the chemical potential and evaporation behavior of other fluids).

A systems and methods can be configured to perform particular operations or actions through an apparatus. One general aspect includes an EMF generator, and also includes a timer relay; pulse-width modulator electrical connected to the timer relay, and a malleable sheet core with electrically conductive wire bundles wrapped around core where the wire bundles are electrically connected to the pulse-width modulator where the EMF generator is configured to be selectively tuned to emit at least one selected frequency.

Implementations may include one or more of the following features. The EMF generator where the timer is configured to activate the relay in a time interval between reversing a current polarity. The relay is a switch configured to tune a frequency emitted by the EMF for a set time. The relay is not integrated into the timer where the relay is configured permit emission of at least a second frequency. A gap separates the first wire bundle or winding from the second wire bundle or winding, where the first winding conducts current in a first direction and where the second winding is insulated from and overlays the first winding and conducts current in a second direction. The malleable sheet core is configured to wrapped around a cylindrical body.

One general aspect includes a method of tuning an electromagnetic field selectively generating an electromagnetic field at a plurality of selected frequencies and strength using an EMF generating device may include a circuit of: a timer relay. The method also includes pulse-width modulator electrical connected to the timer relay; and a malleable sheet core with a plurality of electrically conductive wire bundles wrapped around core where the wire bundles are separated by a gap where the wire bundles are electrically connected to the pulse-width modulator where the EMF generator is configured to be selectively tuned to emit a desired frequency. The method also includes switching a supply between 0 and 100% at a rate faster than it takes a load to change; and generating the desired frequencies and strengths of the electromagnetic field using a combination the EMF generating system where the EMF generating device generates a gradient electromagnetic field, tuned to at least one selected frequency.

Implementations may include one or more of the following features. The method may include directing a direct current through the circuit and switching the direction of the current. The method may include directing a direct current through the circuit and timing the switch. The method may include modulating a gap between the wire bundles. The method may include modulating a time ratio of a primary setting to a secondary setting. The method may include generating an electromagnetic field at a specific frequency for a set time interval, and switching to a second specific frequency for another time interval. The method may include analyzing a water sample to identify chemical components, selecting the EMF generating device to emit selected frequencies.

One general aspect includes a method of activating a solution with an EMF generator initiating an induction field using an EMF generating circuit may include: a timer relay; pulse-width modulator electrical connected to the timer relay; and a malleable sheet core with electrically conductive wire bundles wrapped around core where the wire bundles are separated by a gap where the wire bundles are electrically connected to the circuit, where the EMF generator is configured to be selectively tuned to emit a desired frequency; setting the EMF generator to a selected primary frequency; and switching a current to reverse a polarity; and setting the EMF generator to a selected secondary frequency.

Implementations may include one or more of the following features. The method where the primary frequency is 9,000 hertz for a time interval is 600 seconds. The secondary frequency is 4,671 hertz and a timer interval is 300 seconds. The method may include directing a direct current through the circuit and switching the direction of the current. The method may include directing a direct current through the circuit and timing a switch. The method may include modulating a gap between the wire bundles. The method may include analyzing a water sample to identify chemical components, selecting the EMF generating device to emit selected frequencies.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows a detailed plan view of the EMF device with a PWM.

FIG. 2A shows a schematic of a simple circuit of the EMF device.

FIG. 2B shows the EMF device installed serially on a conduit pipe.

FIG. 3 shows a disclosed method.

FIG. 4 shows a disclosed method.

### DETAILED DESCRIPTION OF THE INVENTION

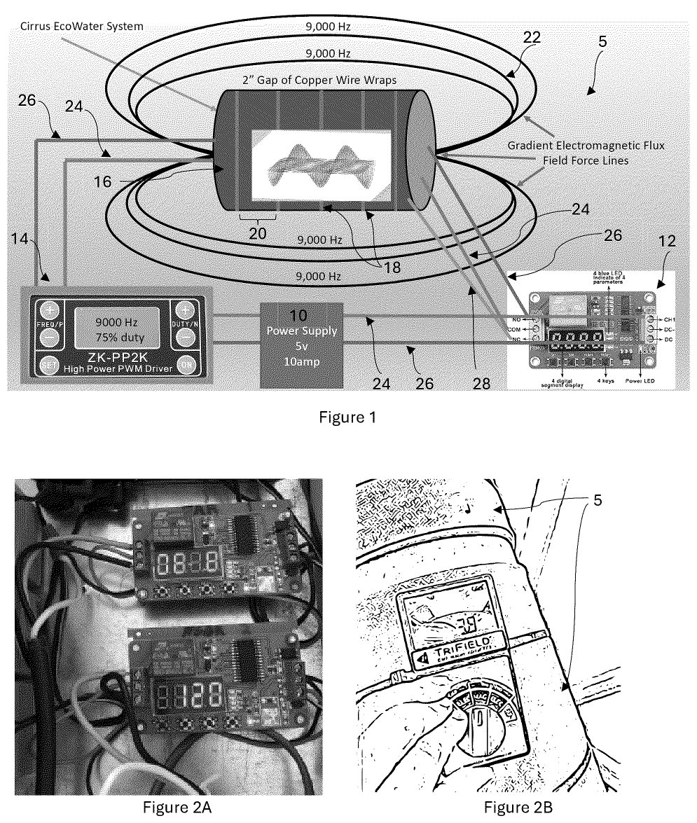

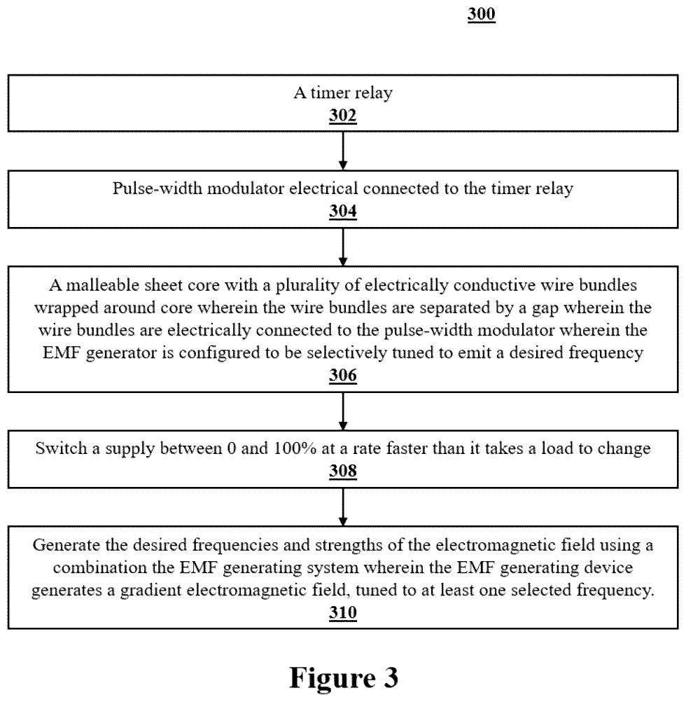

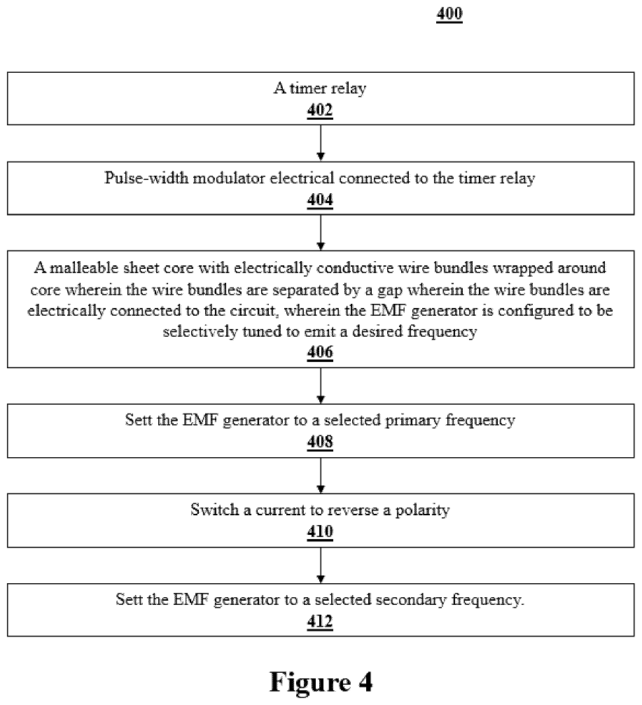

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1 and 2 are not intended to limit the scope of the invention, as claimed, but are merely representative of present embodiments of the invention.

In general, the description discloses an invention that provides a frequency-tunable electromagnetic field in addition to a static magnetic field, to affect minerals suspended in an aqueous solution. Magnetic force lines describe the strength and location of the static magnetic field. The magnetic flux describes the magnetic field that exists (passes through) a specific area. The gradient magnetic field is the change in strength of magnetic field that a fluid, such as water, would experience as it passes the device. The disclosed device may be adjusted such that the emitted EMF presents a specific frequency of electromagnetic energy to impact the scale precipitation mechanism wherein the calcium (and other) ions are accumulated in small, localized prenucleation clusters or colloidal suspensions that are tens of nanometers in diameter. These prenucleation clusters accumulate other hydrated ions to grow until the hydrated ions within them can diffuse within the colloid to assemble a particle large enough to serve as nucleation sites for further crystal growth. In some embodiments passing the water through a magnetic field gradient, the colloidal particles—in which the ions are suspended—are restructured such that they are capable of holding greater numbers of ions before nucleation sites for precipitation are formed. Furthermore, in some embodiments the presence of the magnetic field increases the tendency for the precipitation to form as aragonite rather than calcite (typical hard scale). Aragonite is a less stable form of calcium carbonate (CaCO3) and is found to precipitate as larger particles when the magnetic field gradient is applied. This increase in particle size leads to reduced scaling as the larger particle is less likely to adhere to surfaces due to decreased surface charge, therefore, the aragonite particles remain suspended in the water until they fall out as sediment.

In some embodiments the presence of a changing magnetic field or a magnetic field gradient on water flowing through the field has the effect of increasing the number of intermolecular or hydrogen bonds as well as increasing the strength of the intermolecular bonding. The result is that the heat required to break those bonds and release water molecules from the water surface may be higher, leading to less water evaporation with the same evaporative cooling effect.

In some embodiments, as the water passes through the system, the colloidal particles—in which the ions are suspended—are restructured such that they are capable of holding greater numbers of ions before nucleation sites for precipitation are formed. In some embodiments, this increases the saturation point for ions held in suspension or solution, effectively changing the water from “ion rich” to “ion poor.” In its undersaturated state, the water is “getting” or collecting ions from the surfaces of the system through which it passes. In some embodiments, this accounts for the “de-scaling” that may be observed with water-cooled or other water-system assets. In some embodiments, where the water is allowed to reach or exceed ion saturation, the colloidal particles have been restructured to nucleate as aragonite as opposed to calcite. Aragonite is a polymorph (same chemistry but different crystal structure) of calcium carbonate. Aragonite tends to stay suspended in the water, but if it accumulates on a surface, it presents as a soft, powdery layer, that can be literally wiped away with cloth. In some embodiments the EMF system may be applied to industrial air conditioning systems to keep clean systems clean of scale. In some embodiments, the EMF system may be the results are that clean systems stay clean, and scaled up systems become cleaner.

In some embodiments a combination of low-level alternating and static magnetic fields strengthens the hydrogen bonding of the water which increases cooling power while saving water. In some embodiments strengthened bonds may yield a water savings of over 20% for each day, compared to a day that the system was not used, all while maintaining full cooling power of the AC systems.

In some embodiments the system may inhibit the growth of bacteria in the water, which is important to stay below the recommended maximum level of 500 CFU/ml for potable water and below the EPA safe limit of 10,000 CFU/ml for cooling towers.

In some embodiments tuning the frequency allows for selective targeting of ions found in the water passing through the EMF. Magnesium is typically found in hard water. Magnesium in electronegativity and electron affinity is inherently unstable. As illustrated herein, the invention may be tuned to emit a frequency of 4620 Hertz that resonates with magnesium.

In some embodiments a radio frequency EMF instigates the induction based on the strength and location of the static magnetic field. The gradient magnetic field is the change in strength of magnetic field that the fluid would experience as it passes the device. This is significant to the effectiveness of the device. Radio Frequency is a transmission or energy that travels the electromagnetic spectrum on what we call a radio wave. This does not affect the water as strongly as the source of the transmission itself like a radio tower or antenna. Known EMF generators such as the Cirrus EcoWater System is like an antenna that generates EMF. It is the intensity and frequency of the electromagnetic field emitted from the antenna that makes the changes in substances or even people. Setting the EMF generator to a selected frequency generates the resonance or disruptive resonance which can then reorganize the affected substance at a molecular or atomic level. The pulse-width modulator allows for selected frequencies and the circuit switcher to reverse the polarity as well as select other frequencies. The switcher that would change the polarity of the system would also allow for adding additional frequencies. For example, in some embodiments the primary frequency of 9,000 Hertz is set to the timer for 600 seconds. The secondary frequency can be 4,671 Hertz and the timer setting set to 300 seconds yielding a 2 to 1 ratio. Both the polarity of the field would change causing a disruption, and an additional frequency disruption would help the method of the disruption of equilibrium.

In some embodiments the system can be selectively tuned to specific frequencies ranging from 10⁻¹ Hertz and 10¹⁰ Hertz. These frequencies may include a frequency of 4671 Hertz. In some embodiments the frequency is tuned to 776 Hertz. In some embodiments the frequency is tuned to 9000 Hertz.

In some embodiments the electromagnetic field can be applied to gases. In some embodiments the electromagnetic field can be applied to solids. In some embodiments the electromagnetic field can be applied to other organic and/or inorganic liquids.

Some embodiments comprise an electromagnetic field generator comprising a malleable core with notches, electrically conductive windings wrapped around the flexible core around the notches and an insulative coating which isolates the windings from the core. Some embodiments further comprise a relay that reverses the polarity of the circuit. In some embodiments the relay is coupled to a timer to determine the time interval between reversing the polarity.

In some embodiments comprise an additional wire connected to the circuit and an integrated relay into the timer, thus obviating the need for a separate relay. Some embodiments comprise a non-integrated relay, provided to add more selected frequencies of the applied EMF.

Referring now to FIG. 1, in some embodiments the electromagnetic field generator 5 which may further comprise a system of multiple parts. In some embodiments the electromagnetic field generator 5 further comprises a power supply 10. In some embodiments the electromagnetic field generator comprises a timer relay module 12, such as an FRM01 timer relay. In some embodiments the electromagnetic field generator further comprises a switch configured to reverse polarity. In some embodiments the electromagnetic field generator 5 further comprises a pulse-width modulator 14. In some embodiments the electromagnetic field generator 5 further comprises a core 16. In some embodiments the core 16 is a sheet. In some embodiments the core 16 is malleable capable of wrapping around a cylindrical structure, such as a pipe or limb. In some embodiments the core 16 is wrapped in wire bundles 18. In some embodiments the wire bundles are separated by gaps 20. In some embodiments the core 16 comprises a plurality of bundling sites configured to guide the positioning of wire bundles 18 to desired positions along the body of the core 16. In some embodiments the bundling sites comprise physical depressions into the core 16. In some embodiments the bundling sites structurally extend from the core 16. In some embodiments the bundling site may be an adhesive adhering the bundle 18 to the core 16. In some embodiments the bundles 18 are gapped 20 at substantially uniform intervals. In some embodiments the gaps 20 between bundles 18 may be progressively larger, progressively smaller either from end to end or from end to midbody on the core 16. The bundle gaps 20 are selected based on the characteristics of the gradient field being sought.

In some embodiments the bundles 18 comprise conductive materials such as copper wire. In some embodiments the bundles 18 are wrapped around the core 16 with gaps of approximately 5 cm (2 inches) between the bundle 18 winding. As shown in FIG. 1, the system 5 can be made to various sizes and applications: one wire in one direction after taping the plate 16 and then after taping over the wire the next wire set goes over the first. In some embodiments the system 5 comprises three wires total coming out of the circuit: a first wire 24—Positive, a second wire 28—Positive, and a third wire 26—Neutral or Negative for both, thus allowing for additional frequencies and for the reversal of polarity, leading to additional induction.

In some embodiments the gap 20 between windings is adjusted to create a more dynamic electromagnetic field gradient. This gap 20 increase allows for a less continuous electromagnetic field being generated by the Cirrus EcoWater System and a larger gradient electromagnetic fields. The gap between nodes may be from 0.1 cm to 10 cm. In some embodiments a preferred gap is between 2.5 cm and 8 cm. In some embodiments the most preferred gap between the nodes is between 4.5 cm and 5.5 cm. This change is also staggered for the timer to disrupt the equilibrium of the water of a ratio of 2 to 1 in the timing. Then the pulse-width modulator settings can be a wide range depending on the application such as water, fuel, ammonia, gases, liquids, oils, the human body, animals and solids such as salt.

In some embodiments the pulse-width modulator 14 acts as an EMF tuner. In some embodiments the signal being modulated is input directly from the power supply and the electromagnetic field is modulated by the pulse-width modulator. In some embodiments the signal is modulated to desired frequencies and thus selectively “tuned” to the desired molecular resonance.

As a non-limiting example, in some embodiments the fresh water make up unit is set to 776 Hertz. The primary frequency is typically set to 9,000 Hertz and a secondary frequency is set to 4,671 Hertz. The system is set to a timer and a switcher to switch the polarity at a 2 to 1 ratio. In some embodiments EMF at a first primary frequency is 600 seconds and 300 seconds for the secondary. However, the time intervals can be set in milliseconds, seconds, minutes, hours or days. In some embodiments the frequencies range from 1 Hertz to 10 THz. In some preferred embodiments the frequencies range between 100 Hertz and 150,000 Hertz. In some embodiments precise settings may include 776 Hertz for Phosphates particulate, 4671 Hertz for Magnesium particulate, 9000 Hertz for Silica particulate, 528 Hertz for human tissue. On further testing specific conditions such as headaches, body pain may need immediate attention in a frequency of 5,280 Hertz.

In some embodiments the strength of the gradient magnetic field and electric field increase and can be modulated based on the distance between the nodes. In some embodiments the device is tuning the frequencies. In some embodiments the device is tuning the magnitude or intensity of the fields. In some embodiments the intensity of the fields is controlled by the current driven by the transformer and/or power supply instead of the pulse-width modulator.

In some embodiments a different power source can increase the strength of the magnetic and electrical fields. A 5 volt and 10 amperage power supply can be changed with a 12 volt and 5 amperage power supply. Different frequencies vary the strength of electromagnetic field generator. A frequency lower than 500 Hertz has a much smaller electromagnetic field or higher than 100,000 Hertz has a weaker electromagnetic field. The electric field strength can also be changed with a variation of frequency. In some embodiments the current is set on a duty cycle of 75%. Uniquely, the magnet is turned off and on, thus inducing induction with direct current (DC) power.

In some embodiments the coils around the core are independently activated. In some embodiments additional wires, such as an additional coil, or two coils, wherein one is energized and one not, are activated by a timer that switches at least one of the coils from on to off.

Additional frequencies that can affect other minerals such as iron. Iron resonates at a frequency of 23,675 Hertz or as low as 38 Hertz. Human bone can resonate at 1,500 Hertz to 2,000 Hertz. Different substances, minerals, elements and materials resonate at different frequencies. Additionally, the frequencies can affect human health, liquids, gases and solids not limited irrigation.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. An EMF generator comprising:
a timer relay;
pulse-width modulator electrical connected to the timer relay; and
a malleable sheet core with electrically conductive wire bundles wrapped around core wherein the wire bundles are electrically connected to the pulse-width modulator wherein the EMF generator is configured to be selectively tuned to emit at least one selected frequency.

2. The EMF generator of claim 1 wherein the timer is configured to activate the relay in a time interval between reversing a current polarity.

3. The EMF generator of claim 1 wherein the relay is a switch configured to tune a frequency emitted by the EMF for a set time.

4. The EMF generator of claim 1 wherein the relay is not integrated into the timer wherein the relay is configured permit emission of at least a second frequency.

5. The EMF generator of claim 1 further comprising a first winding and a second winding wherein a gap separates the first winding from the second winding, wherein the first winding conducts current in a first direction and wherein the second winding is insulated from and overlays the first winding and conducts current in a second direction.

6. The EMF generator of claim 1 wherein the malleable sheet core is configured to wrapped around a cylindrical body.

7. A method of tuning an electromagnetic field comprising:
selectively generating an electromagnetic field at a plurality of selected frequencies and strength using an EMF generating device further comprising a circuit of:
a timer relay;
pulse-width modulator electrical connected to the timer relay; and
a malleable sheet core with a plurality of electrically conductive wire bundles wrapped around core wherein the wire bundles are separated by a gap wherein the wire bundles are electrically connected to the pulse-width modulator wherein the EMF generator is configured to be selectively tuned to emit a desired frequency;
switching a supply between 0 and 100% at a rate faster than it takes a load to change; and
generating the desired frequencies and strengths of the electromagnetic field using a combination the EMF generating system wherein the EMF generating device generates a gradient electromagnetic field, tuned to at least one selected frequency.

8. The method of claim 7 further comprising directing a direct current through the circuit and switching the direction of the current.

9. The method of claim 7 further comprising directing a direct current through the circuit and timing the switch.

10. The method of claim 7 further comprising modulating a gap between the wire bundles.

11. The method of claim 7 further comprising modulating a time ratio of a primary setting to a secondary setting.

12. The method of claim 7 further comprising generating an electromagnetic field at a specific frequency for a set time interval; and switching to a second specific frequency for another time interval.

13. The method of claim 7 further comprising analyzing a water sample to identify chemical components; selecting the EMF generating device to emit selected frequencies.

14. A method of activating a solution with an EMF generator comprising:
initiating an induction field using an EMF generating circuit further comprising:
a timer relay;
pulse-width modulator electrical connected to the timer relay; and
a malleable sheet core with electrically conductive wire bundles wrapped around core wherein the wire bundles are separated by a gap wherein the wire bundles are electrically connected to the circuit, wherein the EMF generator is configured to be selectively tuned to emit a desired frequency;
setting the EMF generator to a selected primary frequency; and
switching a current to reverse a polarity; and setting the EMF generator to a selected secondary frequency.

15. The method of claim 14 wherein the primary frequency is 9,000 Hertz for a time interval is 600 seconds.

16. The method of claim 14 wherein the secondary frequency is 4,671 Hertz and a timer interval is 300 seconds.

17. The method of claim 14 further comprising directing a direct current through the circuit and switching the direction of the current.

18. The method of claim 14 further comprising directing a direct current through the circuit and timing a switch.

19. The method of claim 14 further comprising modulating a gap between the wire bundles.

20. The method of claim 14 further comprising analyzing a water sample to identify chemical components; selecting the EMF generating device to emit selected frequencies.
